(19) United States
(12) Patent Application Publication
(10) Pub. No.: US 2020/0048511 A1
(43) Pub. Date: Feb. 13, 2020

(54) POLYISOBUTYLENE BASED PASSIVATION ADHESIVE

(71) Applicant: 3M INNOVATIVE PROPERTIES COMPANY, St. Paul, MN (US)

(72) Inventors: Ying Zhang, Woodbury, MN (US); Vasav Sahni, St. Paul, MN (US); Albert I. Everaerts, Tucson, AZ (US)

(21) Appl. No.: 16/486,037

(22) PCT Filed: Feb. 12, 2018
(86) PCT No.: PCT/US2018/017825

§ 371 Date: Aug. 14, 2019

Related U.S. Application Data
(60) Provisional application No. 62/459,911, filed on Feb. 16, 2017.
(60) Provisional application No. 62/461,580, filed on Feb. 21, 2017.

(51) Int. Cl. C09J 123/22; C09J 7/40; C09J 7/38; B32B 7/12

(52) U.S. Cl. CPC C09J 123/22; C09J 7/405; C09J 7/381; B32B 7/12; B32B 2551/00; B32B 2255/26; B32B 2307/714; B32B 2457/208; C09J 2423/00

(57) ABSTRACT

The present invention is an adhesive composition for use in passivating metallic conductors in an electronic device including at least one low molecular weight polyisobutylene polymer having a weight average molecular weight of about 75,000 or lower, at least one high molecular weight polyisobutylene polymer having a weight average molecular weight of about 120,000 or higher, and optionally, at least one tackifier. Each of the polyisobutylenes and the optional tackifier has a halogen ion content of no more than 1 ppm.

### BACKGROUND

Many types of input devices are presently available for performing operations in an electronic system, such as buttons, keys, mice, touch panels, touch screens and the like. Touch screens, in particular, are becoming increasingly popular because of their intuitive appeal and ease of operation. Touch screens can allow a user to perform various functions by touching the touch sensor panel. To make these devices, silver nanowire, metal mesh (metal could be Cu, Ag, Ag halide), indium tin oxide (ITO) alternatives, are increasingly being utilized. The non-ITO based conducting films have low resistance relative to ITO transparent electrodes, which have high electrical resistance issues especially in large sized touch sensor applications.

Unfortunately, even with lower resistance and cheaper manufacturing cost, the metal based materials are well known to be susceptible to electrochemical oxidation with an oxidant such as oxygen and moisture. The oxidation and the electro-migration between silver or copper traces when under current flow and in elevated temperature/high humidity environment (i.e. 65 degrees C. and 90% humidity) will cause connectivity issues in the electro-conductive trace. Indeed, metallic migration between traces can cause so-called dendritic growth and bridging between traces, which eventually short the circuit. In contrast, corrosion can disrupt the traces and thus the current passing through them.

Organic Light emitting diodes (OLEDs) are increasingly being utilized in displays and light sources because of their lower power consumption, higher response speed and excellent space utilization. The OLED element is very sensitive to moisture or oxygen. The organic luminescent material easily loses its luminescence once it is exposed to moisture, and the highly reactive cathode with low work function will be easily corroded by moisture and oxygen.

### SUMMARY

In one embodiment, the present invention is an adhesive composition for use in passivating metallic conductors in an electronic device. The adhesive composition includes at least one low molecular weight polyisobutylene polymer having a weight average molecular weight of about 75,000 or lower, at least one high molecular weight polyisobutylene polymer having a weight average molecular weight of about 120,000 or higher, and optionally, at least one tackifier. Each of the polyisobutylenes and the optional tackifier has a halogen ion content of no more than 1 ppm.

In another embodiment, the present is adhesive composition for use in passivating metallic conductors in an electronic device composition. The adhesive composition includes at least one low molecular weight polyisobutylene polymer having a weight average molecular weight of about 75,000 or lower, at least one high molecular weight polyisobutylene polymer having a weight average molecular weight of about 120,000 or higher, a passivating agent, and optionally, at least one tackifier

### BRIEF DESCRIPTION OF THE FIGURES

FIG. 1 is a top view of a sample construction for patterned ITO polyester film resistance change measurement.

FIG. 2a is a picture of Comparative Example 1 prior to copper corrosion testing.

FIG. 2b is a picture of Comparative Example 1 after 500 hours of copper corrosion testing at 65° C./90% RH.

FIG. 2c is a picture of Comparative Example 2 prior to copper corrosion testing.

FIG. 2d is a picture of Comparative Example 2 after 500 hours of copper corrosion testing at 65° C./90% RH.

FIG. 2e is a picture of Adhesive Example 1 prior to copper corrosion testing.

FIG. 2f is a picture of Adhesive Example 1 after 500 hours of copper corrosion testing at 65° C./90% RH.

FIG. 2g is a picture of Adhesive Example 2 prior to copper corrosion testing.

FIG. 2h is a picture of Adhesive Example 2 after 500 hours of copper corrosion testing at 65° C./90% RH.

These figures are not drawn to scale and are intended merely for illustrative purposes.

### DETAILED DESCRIPTION

To protect the touch sensor and OLED in an electronic device, a passivation, adhesive is described, which can be directly integrated into an electronic device to protect the sensor and display from moisture, temperature, foreign materials or chemical penetration. The adhesive has a low water vapor transmittance rate (WVTR), low moisture content, low dielectric constant (Dk), and ultraviolet (UV) blocking features. The passivation adhesive described herein can directly contact the metal traces without the need of a separate passivation layer, such as an inorganic oxide or organic coating. Even with low WVTR and low moisture content, the adhesive retains its optical quality during durability testing, i.e., it retains high visible light transmission and low haze. Since this adhesive retains high visible light transmission and low haze, it can advantageously be used in the visible area of the touch sensor panel. Especially those formulations that are color neutral and are color stable under environmental exposure conditions of the device, and be used as optically clear adhesives (OCAs). Additionally, the adhesive described herein provides good compliance, imparts corrosion protection, and provides flow properties to cover the sensor trace, flexible printed circuits (FPC) and any display cover ink step.

In an embodiment, the adhesive comprises polymers made using Lewis Acid catalysts, such as SnCl₄, AlCl₃, BF₃, TiCl₄, polymers made using classical protonic acids: phosphoric, sulfuric, triflic acids, and polymers made using carbenium ion salts: trityl and tropylium cations e.g. polyisobutylene, polybutene, and butyl rubber.ethers.

In an embodiment, the adhesive comprises polyisobutylene (PIB) as the base polymer wherein the PIB is a combination of one or more PIB polymer(s) having each a a weight average molecular weight of 75,000 and below (hereafter “low-molecular weight PIB polymer”), and a combination of one or more PIB polymer(s) having each a weight average molecular weight of 120,000 and above (hereafter “high-molecular weight PIB polymer”). Such weight averages can be determined by gel permeation chromatography against a polystyrene standard.

PIB polymers suitable for use in the adhesive materials described herein, are generally polymers having a polyisobutylene skeleton in the main or a side chain. Fundamentally, such a polyisobutylene polymer can be prepared by polymerizing isobutylene alone or as a combination of isobutylene and n-butene, isoprene, or butadiene in the presence of a Lewis acid catalyst such as aluminum chloride or boron trifluoride. Suitable polyisobutylene polymers are commercially available under the trade designation VISTANEX (Exxon Chemical Co.), HYCAR (Goodrich Corp.), OPPANOL (BASF AG), and JSR BUTYL (Japan Butyl Co., Ltd.). Some of these polyisobutylenes are commercially available with halogen ion levels below the analytical detection limit (so-called B-grades like Oppanol-B), while others may have higher halogen content. B-grade polymers combined with halogen ion-free tackifiers (for example dicyclopentadiene derived tackifiers) may in some cases used without the addition of extra stabilizers or passivating agents for the metals used for the electronic traces. Their low water content and low polarity can provide sufficient passivation to the metals they are in direct contact with. When PIB grades and/or additives with higher halogen ion concentration are used, passivation agents may be required to further passivate the metals under certain environmental exposure conditions.

Under environmental exposure in the presence of halogen ions (e.g. chloride, bromide, fluoride), metal (i.e. copper, aluminum, silver, etc.) corrosion can take place at a significant rate, the corrosion product has negative effect on cosmetics (i.e. copper discoloration) and electro-conductivity. Additionally, the polymers of this invention may contain halogen ion concentrations of greater than 1 ppm, which can cause corrosion of copper and other metals, thus making it undesirable for applications where direct contact with metal traces is a key requirement. When halogen ion concentrations are at a level where corrosion becomes problematic, heterocyclic compounds, especially nitrogen-based ones such as azole derivatives are effective inhibitors or also called passivation agents. Such compounds can coordinate with copper (and some other metals) via their nitrogen atoms lone pair electrons to form complexes with high corrosion resistance. These complexes form an adsorbed protective film on the copper surface, providing inhibition of corrosion by acting as a barrier to aggressive ions such as chlorides. Examples of suitable corrosion inhibitor include, but are not limited to, compounds with electron rich functional groups such as nitrogen, sulfur, and oxygen as well as conjugated double bonds. Examples of such compounds include benzotriazoles, diazoles, triazines, thiols, crown ethers, cinnamic esters, salicylidenes, and the like. Compounds with basic nitrogens can be particularly useful if acidic species are present in the adhesive composition at trace amounts that can be neutralized by such bases.

The low-molecular weight PIB polymer has a weight average molecular weight 75,000 g/mol or below. The high-molecular weight PIB polymer has a weight average molecular weight 120,000 g/mol or above. Applicants have found that the combination of the low and high-molecular weight PIB polymers is particularly advantageous as the combination s provides a broad range of desirable characteristics. Low molecular weight PIB facilitates processing during hot melt extruding, by lowering the melt viscosity of the compounded adhesive mixture. In solvent processing, low molecular weight facilitates faster diffusion of solvent during drying, thus enabling thicker coatings. Also, low molecular weight PIB imparts conformability to an adhesive which enables ink step coverage, and proper wet-out on different surfaces, which are critical features in adhesives. High molecular weight imparts cohesion to an adhesive system which improves the adhesive forces, shear strength, tensile strength, room temperature and high temperature dimensional stability. These properties are critical for adhesives and differing applications may require broad range of composition to accommodate the particular characteristic for each particular application. The amount of low-molecular weight PIB present in the adhesive composition can range between 1-90% by weight and the amount of high-molecular weight PIB present in the adhesive can range between 1-80% by weight. More than one low molecular weight PIB and more than one high molecular weight can be used.

The adhesive compositions disclosed herein may optionally include a tackifier. Addition of tackifiers allows the composition to have higher adhesion which can be beneficial for some applications where adhering to different substrates is a critical requirement. The addition of tackifiers increases the Tg (glass transition temperature) of the composition and can reduce its storage modulus above the Tg, thus making it less elastic and more flowable, such as what is required for compliance to an ink step during lamination. However, that same addition of a tackifier can shift the visco-elastic balance too much towards the viscous behavior, such as in those cases where minimal creep and thus less flow is required. The addition of tackifiers is thus optional, and its presence and concentration is dependent on the particular application.

Suitable tackifiers include non-hydrogenated and hydrogenated aliphatic tackifiers, including so-called C5 resins and dicyclopentadienyl resins. Hydrogenated resins are preferred. These tackifiers are typically used between 1 and 70 parts per hundred by weight based on the polyisobutylene components. In some embodiments, tackifiers are used between 10 and 60 parts per hundred by weight based on the polyisobutylene components.

Other suitable tackifiers include, organic resins, such as wood-based resins such as a rosin resin, a rosin phenol resin, and a rosin ester resin; hydrogenated rosin-based resins obtained by hydrogenating these rosin-based resins; terpene based resins including a terpene phenol-based resins, and an aromatic modified terpene-based resin; and hydrogenated terpene-based resins obtained by hydrogenating these terpene based resins; and resins derived from petroleum, such as C9-based petroleum resins and their hydrogenated versions (cycloaliphatics), or mixed synthetic resins such as those obtained by copolymerizing C9 fractions and C5 fractions of petroleum resins and their hydrogenated versions. These tackifiers may be less miscible and colored, so they are used where slight haze is acceptable and at lower concentrations so the adhesive color is acceptable.

In addition, liquid rheology modifiers, such as plasticizers or oils may also be used. For example mineral oil (Kaydol), napthenic oil (Calsol 5550), paraffinic (Hyprene P100N) etc. The benefit of using a plasticizer/oil in combination with a tackifier is that it allows one to reduce the glass transition temperature of the composition in addition to reducing the storage modulus of the composition. This imparts higher flow characteristics to the composition which is advantageous in applications where conformability to features like ink steps, flex connects etc., is required. In applications requiring defect-free lamination coverage of an ink-step, adhesive compositions with a higher creep compliance are known to provide better ink-step coverage. In one embodiment, a creep compliance of greater than 1.5×10⁴ is suitable for optimal lamination coverage on commercial ink-step features.

The adhesive compositions disclosed herein may further include a UV blocking agent. The UV blocking package includes UV absorbents or combination of UV absorbents and light stabilizers. Examples of suitable UV absorbers include, but are not limited to, benzophenones, benzotriazoles, triazines or combinations of them. Examples of light stabilizers include, but are not limited to, hindered amine light stabilizers (HALS). The adhesive sheet of the present invention can have neutral color and low haze, which is required for an optically clear adhesive. The adhesive sheet of this invention has a sharp UV cut-off, examples of UV cut-off include, but are not limited to, transmittance (% T) less than 1.5% at 380 nm wavelength, 84% at 400 nm wavelength and higher than 96% at 410 nm wavelength and above, which can block UV light or even purple light efficiently, but does not cause too much yellow color.

The adhesive compositions disclosed herein may further include additional additives such as primary and secondary antioxidants, in-process stabilizers, light stabilizers, processing aids, and elastomeric polymers, nanoscale fillers, transparent fillers, getter/scavenger fillers, desiccants, crosslinkers, pigments, extender, softener, resin stabilizers. These additives may be used singly and in combination of two or more kinds thereof.

In certain embodiments, if any of the components in the adhesive composition (polymer, tackifier, or any of the aforementioned additives) contains more than 1 ppm of halogen ions, an additional additive, hereafter referred to as a “passivating agent” as described above, is typically added in the concentration range of about 0.1 weight % to 3 weight % based on the total solids of the adhesive composition. This allows the adhesive composition to be non-corrosive to metals.

In certain embodiments, the pressure-sensitive adhesive compositions containing the PIBs are optically clear. Thus, certain articles can be laminates that include an optically clear substrate (e.g., an optical substrate such as an optical film) and an optically clear adhesive layer of the PIB pressure sensitive adhesive composition adjacent to at least one major surface of the optically clear substrate. The laminates can further include a second substrate permanently or temporarily attached to the pressure-sensitive adhesive layer and with the pressure-sensitive adhesive layer being positioned between the optically clear substrate and the second substrate.

In some example laminates in which an optically clear pressure-sensitive adhesive layer (i.e., the PIB based pressure-sensitive adhesive composition described herein) is positioned between two substrates, at least one of the substrates is an optical film, a display unit, a touch sensor, or a lens. Optical films intentionally enhance, manipulate, control, maintain, transmit, reflect, refract, absorb, retard, or otherwise alter light that impinges upon a surface of the optical film. Optical films included in the laminates include classes of material that have optical functions, such as polarizers, interference polarizers, reflective polarizers, diffusers, colored optical films, mirrors, louvered optical film, light control films, transparent sheets, brightness enhancement film, anti-glare, and anti-reflective films, and the like. Optical films for the provided laminates can also include retarder plates such as quarter-wave and half-wave phase retardation optical elements. Other optically clear films can include clear plastics (such as polyester, cyclic olefin copolymer, clear polyimide, polycarbonate, or polymethylmethacrylate), anti-splinter films, and electromagnetic interference filters. Some of these films may also be used as substrates for ITO (i.e., indium tin oxide) coating or patterning, such as use those used for the fabrication of touch sensors. The low water uptake and WVTR of the PIB adhesives of this invention provide a stable, low dielectric constant adhesive which can be very advantageous for use in touch sensor applications, both to protect the sensor and integrating conductors from the environment and corrosion, and also to minimize electronic noise communication with the sensor.

In some embodiments, laminates that include a PIB pressure-sensitive adhesive as describe herein can be optical elements, or can be used to prepare optical elements. As used herein, the term “optical element” refers to an article that has an optical effect or optical application. The optical elements can be used, for example, in electronic displays (e.g., liquid crystal displays (LCDs), organic light emitting displays (OLEDs), architectural applications, transportation applications, projection applications, photonics applications, and graphics applications. Suitable optical elements include, but are not limited to, glazing (e.g., windows and windshields), screens or displays, polarizing beam splitters, ITO-coated touch sensors such as those using glass or clear plastic substrates, and reflectors.

In addition to various optics-related applications and/or electronic display assembly applications, the PIB pressure-sensitive adhesive compositions can be used in a variety of other applications. For example, an article can be formed by forming a layer (e.g., film) of a pressure-sensitive adhesive composition on a backing or release liner. If a release liner is used, the layer can be transferred to another substrate. The other substrate can be, for example, a component of an electronic display assembly. That is, the layer can be laminated to another substrate. The film is often laminated between a first substrate and a second substrate (i.e., the layer of pressure-sensitive adhesive is positioned between the first substrate and the second substrate).

Although the invention is further explained in detail using the examples, they do not give rise to any restriction to the invention.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis.

TABLE 1
Materials

| Chemical names | Suppliers |
|---|---|
| Escorez 5300 | Exxon Mobile Chemical |
| BHT: Di-tert-butyl-4-Methylphenol | Sigma Aldrich |
| Oppanol B15 | BASF |
| Oppanol B50 | BASF |
| Oppanol B80 | BASF |
| Oppanol N50 | BASF |
| Oppanol N80 | BASF |
| Tinuvin 928 | BASF |
| Tinuvin 123 | BASF |
| Tinuvin 477 | BASF |
| 2-amino-5-(ethylthio)-1,3,4-thiadiazole | Sigma-Aldrich |
| 2-amino-5-ethyl-1,3,4-thiadiazole | Sigma-Aldrich |
| 4-amono-5-phenyl-4H-1,2,4-triazole-3-thiol | Sigma-Aldrich |
| N,N′-ethylene-bis(salicylideneimine) | Sigma-Aldrich |
| N,N′-Bissalicylidene-1,2-propanediamine | Sigma-Aldrich |
| RF 32N release liner | SKC Hass |
| RF 02N release liner | SKC Haas |

### Comparative Example-1

Oppanol N50/N80/Escorez 5300=25/50/25 (parts by mass) was dissolved with heptane to make homogeneous solution. To this solution, Tinuvin 928, Tinuvin 477, Tinuvin 123 and BHT were added in the ratios of 4.2, 0.3, 0.6, and 0.06 mass parts per hundred respectively based on dry polymer and resin mass. Then, the prepared solution was coated on a 50 μm-thick release film RF22N and dried in an oven at 70° C. for 30 minutes. The thickness of the PSA after drying was 25 μm. Subsequently, this PSA surface was laminated with a 50 μm-thick release film RF02N. The sample has a 60 C/5 min creep compliance 0.50×10⁻⁴.

### Comparative Example-2

Oppanol B15/N80/Escorez 5300=80/20/20 (parts by mass) was dissolved with heptane to make homogeneous solution. To this solution, Tinuvin 928, Tinuvin 477, Tinuvin 123 and BHT were added in the ratios of 4.2, 0.3, 0.6, and 0.06 mass parts per hundred respectively based on dry polymer and resin mass. Then, the prepared solution was coated on a 50 μm-thick release film RF22N and dried in an oven at 70° C. for 30 minutes. The thickness of the PSA after drying was 25 μm. Subsequently, this PSA surface was laminated with a 50 μm-thick release film RF02N. The sample has a 60 C/5 min creep compliance 1.84×10⁻⁴.

### Adhesive Example-1

Oppanol B50/B80/Escorez 5300=25/50/25 (parts by mass) was dissolved with heptane to make homogeneous solution. To this solution, Tinuvin 928, Tinuvin 477, Tinuvin 123, and BHT were added in the ratios of 4.2, 0.3, 0.6, and 0.06 mass parts per hundred respectively based on dry polymer and resin mass. Then, the prepared solution was coated on a 50 μm-thick release film RF22N and dried in an oven at 70° C. for 30 minutes. The thickness of the PSA after drying was 25 μm. Subsequently, this PSA surface was laminated with a 50 μm-thick release film RF02N. The sample has a 60 C/5 min creep compliance 0.50×10⁻⁴.

### Adhesive Example-2

Oppanol B15/N80/Escorez 5300=80/20/20 (parts by mass) was dissolved with heptane to make homogeneous solution. To this solution, Tinuvin 928, Tinuvin 477, Tinuvin 123, BHT and 4-amono-5-phenyl-4H-1,2,4-triazole-3-thiol were added in the ratios of 4.2, 0.3, 0.6, 0.06 and 0.04 mass parts per hundred respectively based on dry polymer and resin mass. Then, the prepared solution was coated on a 50 □m-thick release film RF22N and dried in an oven at 70° C. for 30 minutes. The thickness of the PSA after drying was 25 μm. Subsequently, this PSA surface was laminated with a 50 μm-thick release film RF02N. The sample has a 60 C/5 min creep compliance 1.84×10⁻⁴

### Copper Corrosion Testing:

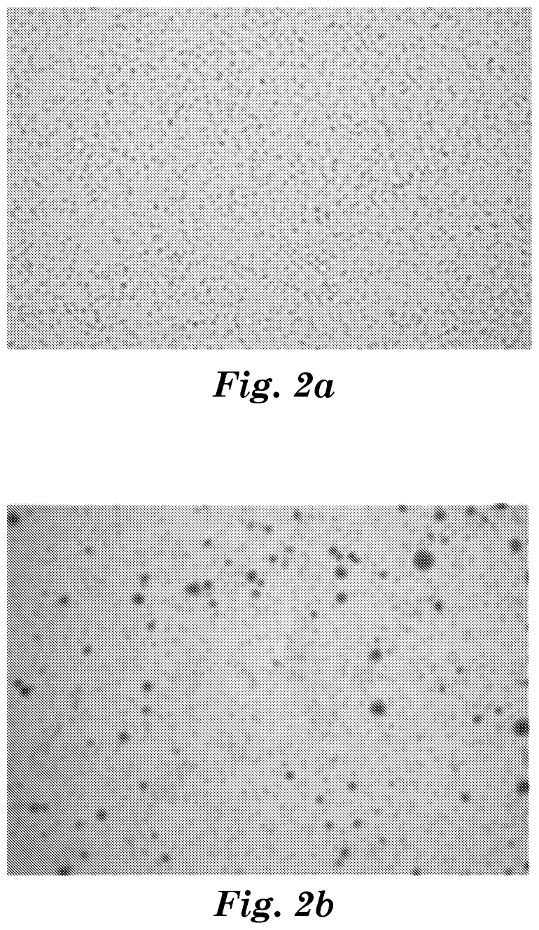

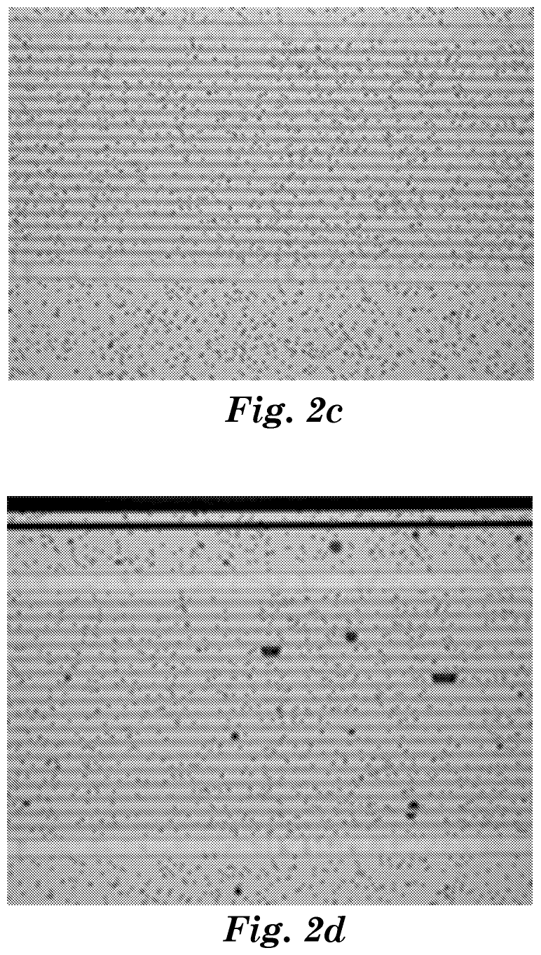

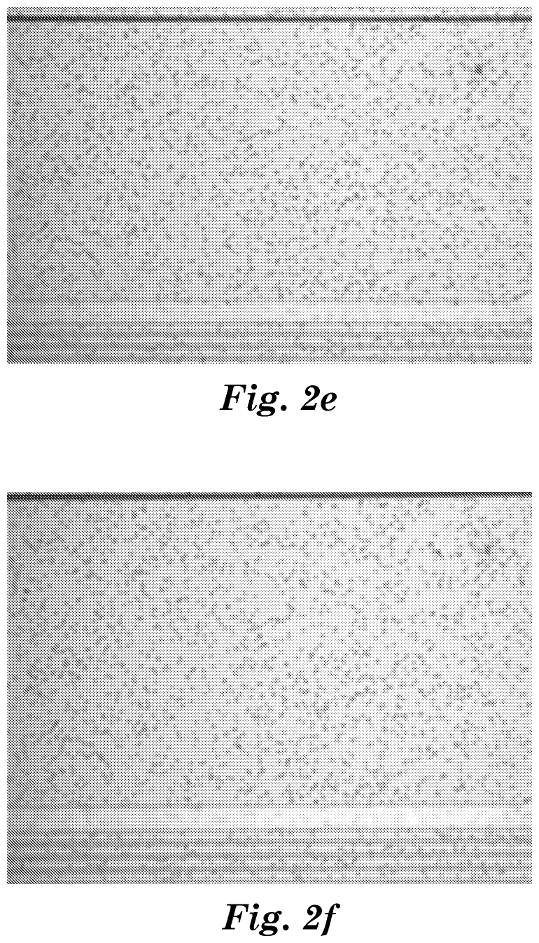

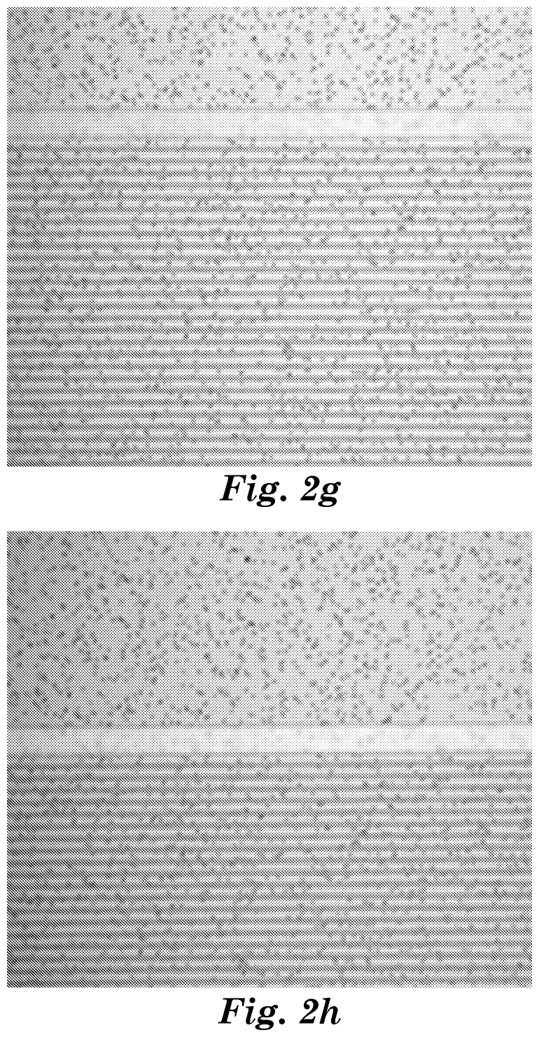

Remove clear liner from a 2 inch by 3 inch adhesive strip and attach it in direct contact with both sides of the copper sheet. Secure the transfer tape with four passes of a small rubber hand roller, making sure no air bubbles are entrapped. Remove the second liner from one side and laminate the adhesive strip to LCD glass. Then remove the other side release liner and place into 65° C./90% RH for 500 hours. Inspect under 50× microscope and record any corrosion seen, relative to top side copper sheet (non-LCD side). The testing results are shown in FIGS. 2a-2h.

### Testing Method to Determine Cohesive Integrity (Creep Compliance Test)

Samples were evaluated for their creep compliance (J) at 60° C. using a rheological dynamic analyzer (Model DHR-3 Rheometer, which is available from TA Instruments, New Castle, Del., USA) equipped with a Peltier Plate heating fixture. Samples were prepared by coating the polymeric material onto a silicone release liner and drying it at 160° C. in a vacuum oven. The resulting polymeric film was then pressed at 140° C. to a thickness of approximately 1 millimeter (0.039 inches). After allowing to cool under ambient conditions to room temperature, samples were then punched out using an 8 millimeter (0.315 inches) diameter circular die, and adhered onto an 8 millimeter diameter upper parallel plate after removal of the release liner. The plate with polymeric film was positioned over and onto the Peltier Plate in the rheometer with the exposed polymeric sample surface contacting the Peltier Plate, and the polymeric film compressed until the edges of the sample were uniform with the edges of the top plate. The temperature was then equilibrated at the test temperatures for 2 minutes at a nominal axial force of 0 grams+/−15 grams. After two minutes, the axial force controller was disabled in order to maintain a fixed gap during the remainder of the test. A stress of 8,000 Pascals was applied to the sample for 300 seconds, and the creep compliance (J) at 287 seconds was recorded.

### ITO Compatibility Testing

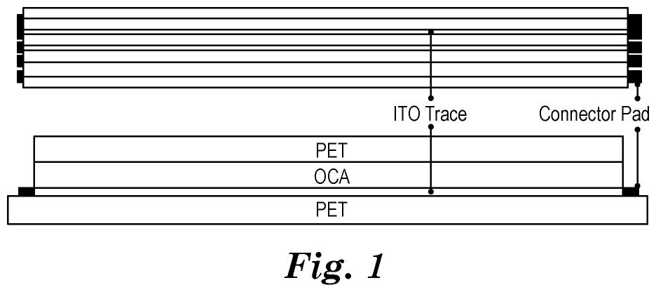

Remove clear liners and laminate adhesive samples between 2 mil SH81 polyester (PET, from SKC Films) and indium tin oxide (ITO) patterned PET. Then the ITO patterned PET was taped to glass for support and each test strip contained six circuits as shown in FIG. 1. Measure the resistance (in kOhm) for each circuit with EXTECH Multimeter 380198 and average them as the initial resistance R₀ without environmental exposure. Then the samples were placed in a 65° C./90% RH environmental chamber and measured after t hours environmental exposure Rₜ. The percent resistance change vs. environmental exposure time was calculated as follows: % resistance change=100*(R₁−R₀)/R₀, where R₀ is the initial resistance without environmental exposure, Rₜ is the resistance after t hours environmental exposure. The testing results were summarized in Table 2.

TABLE 2
ITO compatibility under heat soak condition (65° C./90% RH)

| Time at 65° C./90% RH | % Change in Resistance | |
|---|---|---|
| (Hours) | Control (ITO alone) | Adhesive example-2 |
| 0 | 0.0% | 0.0% |
| 100 | −0.9% | −1.0% |
| 200 | 0.7% | 0.0% |
| 300 | 1.8% | 0.5% |
| 500 | 5.8% | 2.4% |
| 800 | 8.4% | 4.2% |

### Ink Step Coverage and Durability Testing

An adhesive sample was hand laminated to 10 μm thick ink step printed glass (i.e. 40% of the 25 micron adhesive thickness), then autoclaved at 60° C. and pressure 6 kg/cm² for 15 minutes. The adhesive overlap with the ink step was about 0.2 to 0.5 mm. Then, the second release liner was removed from the adhesive and a 2 mil SH 81 PET was hand-laminated, and the sample was ran through a 40 PSI pressurized rubber roller laminator. The sample was then autoclaved again at condition of 60° C. and pressure 6 kg/cm² for 15 minutes. Then the samples were conditioned in an environmental chamber for durability testing. After certain time interval, check for bubbles or delamination. The results are summarized in Table 3, where “good” means that no bubbles or delamination was observed. The tabled indication of “Not good” means that bubbles, delamination, or both were observed.

In applications requiring defect-free lamination coverage of an ink-step, adhesive compositions with a higher creep compliance are known to provide better ink-step coverage. In one embodiment, a creep compliance of greater than 1.5×10⁴ is suitable for optimal lamination coverage on commercial ink-step features.

TABLE 3
Ink step coverage lamination and durability testing results

| | Before | After | Environmental | | | | | |
|---|---|---|---|---|---|---|---|---|
| Sample ID | autoclave | autoclave | conditions | 100 hrs | 200 hrs | 300 hrs | 500 hrs | 800 hrs |
| Comp. | Not | Not | 65° C./90% RH | NA | | | | |
| Example-2 | Good | Good | | | | | | |
| | Not | Not | 85 C./85% RH | NA | | | | |
| | Good | Good | | | | | | |
| | Not | Not | 85 C. | NA | | | | |
| | Good | Good | | | | | | |
| Adhesive | good | good | 65 C./90% RH | No | No | No | No | No |
| Example-2 | | | | change | change | change | change | change |
| | good | good | 85 C./85% RH | No | No | No | No | No |
| | | | | change | change | change | change | change |
| | good | good | 85 C. | No | No | No | No | No |
| | | | | change | change | change | change | change |

### Dielectric Constant (Dk) and Dielectric Constant Stability Measurement Method:

Raw samples should be prepared to physically fit into the environmental chamber and capacitance measurement apparatus. One liner should be removed before putting the samples into heat soak (HS) chamber. The thickness of the sample during HS exposure is 150 μm and the exposure condition is 65° C. at 90% relative humidity. The sample(s) should be soaked in the environmental condition specified time such as 0, 72, 168, 336 and 504 hrs. After the soak time, the sample(s) should be taken out of chamber and allowed to rest 24 hours at room temperature and humidity conditions, namely, 25° C. and 40-45% RH. Prior to Dk measurement, laminate two 150 μm pieces together. Then dielectric constant measurements should be performed on the samples. The measurement equipment can be located in standard working room conditions. The dielectric constant and electrical dissipation factor (tan delta) were measured using the broadband Novocontrol Dielectric Spectrometer per ASTM D150.

1. An adhesive composition for use in passivating metallic conductors in an electronic device comprising:
at least one low molecular weight polyisobutylene polymer having a weight average molecular weight of about 75,000 or lower;
at least one high molecular weight polyisobutylene polymer having a weight average molecular weight of about 120,000 or higher; and
optionally, at least one tackifier,
wherein each of the polyisobutylenes and the optional tackifier has a halogen ion content of no more than 1 ppm.

2. An adhesive composition for use in passivating metallic conductors in an electronic device composition comprising:
at least one low molecular weight polyisobutylene polymer having a weight average molecular weight of about 75,000 or lower;
at least one high molecular weight polyisobutylene polymer having a weight average molecular weight of about 120,000 or higher;
a passivating agent; and
optionally, at least one tackifier.

3. The adhesive composition of claim 1 for use in passivating an electronic device, wherein the composition has a 60° C./5 minute creep compliance greater than 1.5×10−4.

4. The adhesive composition of claim 2, wherein the passivating agent is present in an amount of about 0.1% to about 3% based on total solids.

5. The adhesive composition of claim 1, wherein the tackifier is present and is a non-hydrogenated or hydrogenated aliphatic hydrocarbon tackifier.

6. The adhesive composition for use in passivating an electronic device of claim 5, wherein the weight percent of components is: 1-90% low molecular weight polyisobutylene, 1-80% high molecular weight polyisobutylene, and 1-60% tackifier.

7. The adhesive composition of claim 1, wherein the thickness of the adhesive is 0.001-1 mm.

8. The adhesive composition of claim 1, wherein the composition is not crosslinked.

9. The adhesive composition of claim 1, wherein the composition is coated on a substrate.

10. The adhesive composition of claim 1, wherein the composition is positioned between two substrates.

11. (canceled)

12. The adhesive composition of claim 10 wherein one or more of the substrates is an optical film, a display unit, a touch sensor, a release liner, or a lens.

13. The adhesive composition of claim 2 for use in passivating an electronic device, wherein the composition has a 60° C./5 minute creep compliance greater than 1.5×10−4.

14. The adhesive composition of claim 2, wherein the tackifier is present and is a non-hydrogenated or hydrogenated aliphatic hydrocarbon tackifier.

15. The adhesive composition for use in passivating an electronic device of claim 14, wherein the weight percent of components is: 1-90% low molecular weight polyisobutylene, 1-80% high molecular weight polyisobutylene, and 1-60% tackifier.

16. The adhesive composition of claim 2, wherein the thickness of the adhesive is 0.001-1 mm.

17. The adhesive composition of claim 2, wherein the composition is not crosslinked.

18. The adhesive composition of claim 2, wherein the composition is coated on a substrate.

19. The adhesive composition of claim 2, wherein the composition is positioned between two substrates.

20. The adhesive composition of claim 18, wherein one or more of the substrates is an optical film, a display unit, a touch sensor, a release liner, or a lens.

21. The adhesive composition of claim 19, wherein one or more of the substrates is an optical film, a display unit, a touch sensor, a release liner, or a lens.
